(19) United States
(12) Patent Application Publication
(10) Pub. No.: US 2007/0237408 A1
(43) Pub. Date: Oct. 11, 2007

(54) Image processing apparatus and image processing method

(75) Inventor: Masaaki Yasunaga, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/398,230

(22) Filed: Apr. 5, 2006

(51) Int. Cl. G06K 9/36; G06K 9/34

(52) U.S. Cl. 382/239; 382/176

(57) ABSTRACT

An image processing apparatus according to the invention is characterized by comprising: a character area separating unit for separating a character area image and a background area image of bit map image data by means of layout analysis; a character kind discriminating unit for comparing the number of character colors of a character part of the character area image separated by means of the character area separating unit with a preset threshold of the number of character colors to select a first processing series when the number of character colors of the character part is equal to or less than the threshold and to select a second processing series when the number of character colors of the character part exceeds the threshold; a character part extracting unit for extracting a character part image from the character area image for which the first processing series is selected by means of the character kind discriminating unit; a binary-changing unit for binary-changing the character part image extracted by means of the character part extracting unit; a binary compression unit for binary-compressing the binary-changed image binary-changed by means of the binary-changing unit; and a multi-value compression unit for multi-value-compressing the character area image for which the second processing series is selected by means of the character kind discriminating unit. According to the image processing apparatus in accordance with the invention, it is judged that a character included in a character area image extracted from a bit map image data by layout analysis is a monochromatic character or a plural-color character such as a gradation character to apply a process and compression suitable for each character. This allows efficient compression data including small loss in character color data to be created.

### BACKGROUND OF THE INVENTION

1. Technical Field of the Invention

The present invention relates to an image processing technology, particularly, an image processing apparatus and an image processing method for discriminating an attribute of a character included in a character area image extracted from bit map image data by layout analysis to create efficient compression data.

2. Related Art

Recently, many documents have been digitized as a digital technology advances. This requires efficient control of a mass of digitized documents. In order to efficiently control documents, used is a method of compressing digitized document data to make its capacity small. There is, for example, a method for forming data into binary data or multi-value data and performing compression suitable for each of the binary data and the multi-value data so as to efficiently carry out high compression. The data, which is formed into parts and highly compressed, can be compounded by means of a viewer to roughly reproduce an original image.

As a file format using such image composition, known has been a PDF (portable document format) and the like. In the case of the PDF, however, a character including plural mixed colors such as a gradation character, a texture character, which is a character having a texture, or the like cannot be properly expressed when data is formed into parts for every certain range of color, so that necessary information is likely to be lost.

In view of the above, conventionally opened to the public are Patent Reference 1 (JP-A-2004-336211) and Patent Reference 2 (JP-A-2004-242075).

With a compression processing method disclosed in Patent Reference 1, however, a texture character cannot be properly reproduced and a problem that necessary information is lost cannot be solved.

Further, the compression processing method disclosed in Patent Reference 1 has a problem that it takes time for processing since all area is blocked without separating a character area and a background area such as a photograph to discriminate color information for each block.

Moreover, in the compression processing method disclosed in Patent Reference 1, a means for holding information such as a gradation character has plural binary images in different tones, which are pasted one by one to express a gradation in appearance. This causes a problem that a fine gradation cannot be reproduced.

In addition, in the compression processing method disclosed in Patent Reference 1, color data is discriminated whether color data is a color binary data or not before judging whether the color binary data is a gradation data or not. This causes a problem that a surplus process is performed in the case that the color data is a gradation.

In an image processing method disclosed in Patent Reference 2, a color subtraction process is carried out for a character in plural colors such as a gradation character to virtually hold the character as color data. There is, however, a problem that data cannot be held well since colors are expressed in steps in the case of a gradation character and the like, similarly to the compression processing method in Patent Reference 1.

In a technology for holding plural binary images in different tones in order to hold information such as a gradation character like the compression processing method in Patent Reference 1 or the image processing method in Patent Reference 2, colors of a reproduced gradation character are changed in steps. This causes a problem that such a change is uncomfortable for a user.

Further, there is provided a method of increasing the number of color planes to increase tones for the purpose of smoothing a change in color of a gradation character. This method, however, has a problem that the data quantity increases so much that efficient control of documents is likely to be hindered.

### SUMMARY OF THE INVENTION

In view of the above, an object of the invention is to carry out a process and compression suitable for an attribute of a character included in a character area image extracted by layout-analyzing bit map image data to create efficient compression data including small loss in character color data.

In order to achieve the above object, an image processing apparatus in accordance with the invention is an image processing apparatus comprising: a character area separating unit for separating a character area image and a background area image of bit map image data by means of layout analysis; a character kind discriminating unit for comparing the number of character colors of a character part of the character area image separated by means of the character area separating unit with a preset threshold of the number of character colors to select a first processing series when the number of character colors of the character part is equal to or less than the threshold and to select a second processing series when the number of character colors of the character part exceeds the threshold; a character part extracting unit for extracting a character part image from the character area image for which the first processing series is selected by means of the character kind discriminating unit; a binary-changing unit for binary-changing the character part image extracted by means of the character part extracting unit; a binary compression unit for binary-compressing a binary-changed image binary-changed by means of the binary-changing unit; and a multi-value compression unit for multi-value-compressing the character area image for which the second processing series is selected by means of the character kind discriminating unit.

Further, in order to achieve the above object, an image processing method in accordance with the invention is an image processing method comprising: a character area separating step for separating a character area image and a background area image of bit map image data by means of layout analysis; a character kind discriminating step for comparing the number of character colors of a character part of the character area image separated in the character area separating step with a preset threshold of the number of character colors to select a first processing series when the number of character colors of the character part is equal to or less than the threshold and to select a second processing series when the number of character colors of the character part exceeds the threshold; a character part extracting step for extracting a character part image from the character area image for which the first processing series is selected in the character kind discriminating step; a binary-changing step for binary-changing the character part image extracted in the character part extracting step; a binary compression step for binary-compressing a binary-changed image binary-changed in the binary-changing step; and a multi-value compression step for multi-value-compressing the character area image for which the second processing series is selected in the character kind discriminating step.

### BRIEF DESCRIPTION OF THE DRAWINGS

In the accompanying drawings,

FIG. 1 is a functional block diagram showing a first embodiment of an image processing apparatus in accordance with the invention;

FIG. 2 is a flowchart showing an operation of the first embodiment of an image processing apparatus in accordance with the invention;

FIG. 3 is a functional block diagram showing a second embodiment of the image processing apparatus in accordance with the invention;

FIG. 4 is a flowchart showing an operation of the second embodiment of the image processing apparatus in accordance with the invention;

FIG. 5 is a functional block diagram showing a third embodiment of the image processing apparatus in accordance with the invention;

FIG. 6 is a flowchart showing an operation of the third embodiment of the image processing apparatus in accordance with the invention;

FIG. 7 is a functional block diagram of a first example of a character area image improving unit.

FIG. 8 is a flowchart showing an operation of the first example of a character area image improving unit.

FIG. 9 is a functional block diagram of a second example of the character area image improving unit.

FIG. 10 is a flowchart showing an operation of the second example of the character area image improving unit.

FIG. 11 is a functional block diagram of a third example of the character area image improving unit.

FIG. 12 is a flowchart showing an operation of the third example of the character area image improving unit.

FIG. 13 is a functional block diagram of a fourth example of the character area image improving unit.

FIG. 14 is a flowchart showing an operation of the fourth example of the character area image improving unit.

FIG. 15 is a functional block diagram of a fourth embodiment of the image processing apparatus in accordance with the invention.

FIG. 16 is a flowchart showing an operation of the fourth embodiment of the image processing apparatus in accordance with the invention.

### DETAILED DESCRIPTION OF THE PREFERRED EMBODIMENTS

Embodiments of the image processing apparatus and the image processing method in accordance with the invention will be described, made reference to the attached drawings.

Embodiments of the image processing apparatus in accordance with the invention will be described with reference to the attached drawings.

### First Embodiment

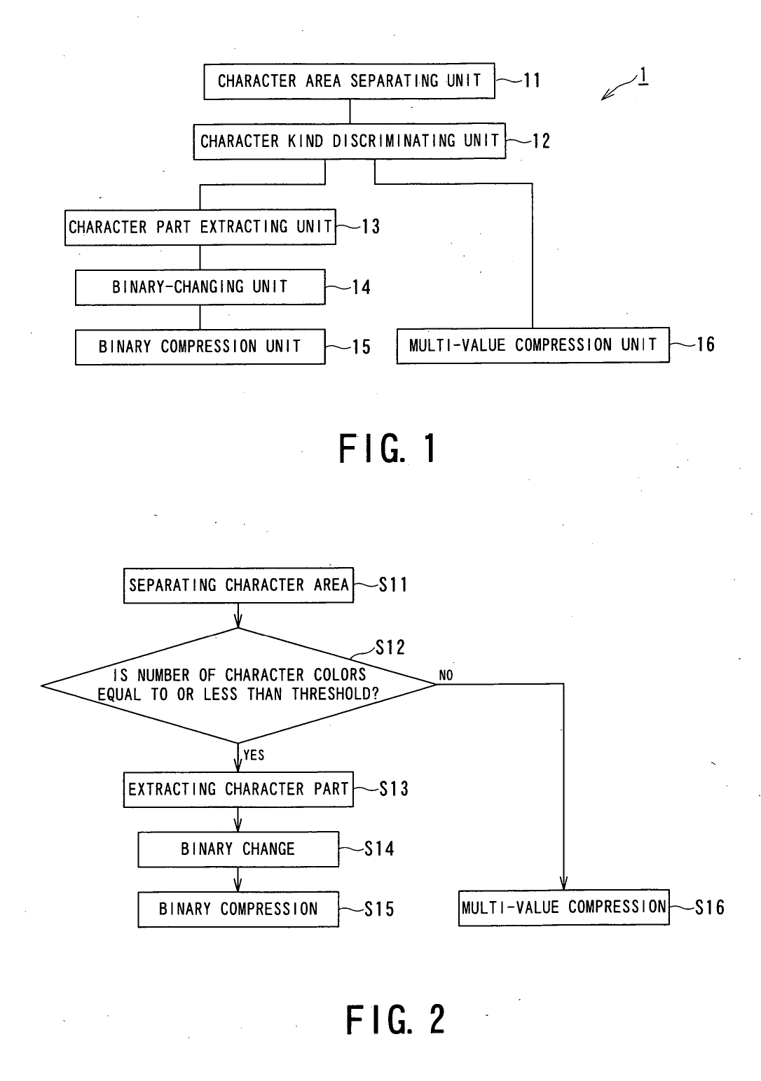

FIG. 1 is a functional block diagram showing an image processing apparatus 1 in accordance with the invention.

An image processing apparatus 1 comprises a character area separating unit 11, a character kind discriminating unit 12 connected to the character area separating unit 11, a character part extracting unit 13 connected to the character kind discriminating unit 12, a binary-changing unit 14 connected to the character part extracting unit 13, a binary compression unit 15 connected to the binary-changing unit 14 and a multi-value compression unit 16 connected to the character kind discriminating unit 12.

The character area separating unit 11 detects a character area image and a background area image from bit map image data by layout analysis to separate the images, respectively. To the layout analysis, applied can be a well-known method.

The character area image in the above context means an image in a character area. The character area means an area in which a part including a character or a row of characters in bit map image data, the part being obtained as a result of layout analysis, is separated from the bit map image data together with the background in the vicinity of the character part forming a character per se.

Accordingly, the character area image is an image including not only a character per se but also a background image in the vicinity of the character part. Separation of the character area is performed so that the part including a character part of a character or a character part in a row of characters would be cut into a rectangular shape together with the background, for example. When the part is cut into a rectangular shape as described above, the character area image is in a rectangular shape as a whole and formed from two parts, one of which is an image in the character part and the other of which is a background part remaining after removing the character part from a rectangular frame.

The character kind discriminating unit 12 carries out an operation of detecting the number of character colors in a character part of the character area image separated by means of the character area separating unit 11 to select a subsequent process for the character area image in accordance with the detected number of character colors.

Concretely, the character kind discriminating unit 12 compares the number of character colors in the character part in the character area image, which is separated by means of the character area separating unit 11, with a preset threshold of the number of character colors to select a first processing series as a subsequent process when the number of character colors in the character part is equal to or less than the threshold and to select a second processing series as a subsequent process when the number of character colors in the character part exceeds the threshold. The threshold of the number of character colors can be two, for example.

The first processing series in the above context means a series in which processes are carried out at least by means of the character part extracting unit 13 and the binary-changing unit 14 after the process by means of the character kind discriminating unit 12.

The second processing series in the above context means a series in which processes are performed other than the first processing series after the process by means of the character kind discriminating unit 12.

As a method of detecting the number of character colors in the character part in the character area image, which is separated by means of the character area separating unit 11, used are a method of judgment based on color information obtained from a specified area of the character part of the character area image and a method of judgment based on a histogram of the character part of the character area image, for example.

The method of judgment based on color information obtained from a specified area of the character part of the character area image is a method of detecting a color in a specific area of the character part, namely, five points of the center, upper-left, lower-left, upper-right and lower-right parts of the character part, for example, to make a judgment of a monochromatic character when there is no change in color in the five points and to make a judgment of a plural-color character such as a gradation character, for example, when there is a change in color in the five points. The character part in which the specific area is set may be one character or plural characters.

When there is a change in color in every specific area in the case that the character part in which the specific area is set is one character, it can be judged that the character is a gradation character or a texture character, for example. The gradation character in the above context means a character having a gradation of color. The texture character in the above context means a character having a texture.

On the other hand, when there is a change in color in every specific area in the case that the character part in which the specific area is set is plural characters, it can be judged that the plural characters are any one of a gathering of monochromatic characters, which are different in color, a gathering of gradation characters and/or texture characters or a combination of a monochromatic character and a gradation or texture character, for example.

The method of judgment based on a histogram of the character part of the character area image is a method of judging the number of character colors on the basis of a change in histogram of the character part of the character area image. As the histogram, used is an RGB histogram or an HSV histogram, for example. A judgment of a monochromatic character is made when there is no change in histogram while a judgment of non-monochromatic character is made when there is a change in histogram.

A relation between a change in histogram and a threshold of the number of character colors set in advance in the character kind discriminating unit 12, namely, which kind of change in histogram corresponds to which degree of the number of character colors is properly set.

The character part extracting unit 13 carries out a process of extracting a character part image from a character area image for which the first processing series is selected by means of the character kind discriminating unit 12. The character part image in the above context means an image of the character part per se. A character area image before extracting the character part image includes a little a background image in the vicinity of the character part. Extracting the character part image, however, allows an image, which only includes a character part without including a background image, to be obtained.

Extraction by means of the character part extracting unit 13 is performed for a character area image for which the first processing series is selected by means of the character kind discriminating unit 12, namely, a character area image in which the number of character colors in the character part of the character area image detected by means of the character kind discriminating unit 12 is equal to or less than the preset threshold of the number of character colors.

When the threshold is two or more, the character part is sometimes formed from two or more colors in the character area image for which the first processing series is selected. In this case, in extraction in the character part extracting unit 13, planes of respective colors in the character area image are created first, and then, the character part images are extracted from the color planes.

The planes are created so that the number thereof would correspond to the number of detected character colors. In the case that the threshold is two and the number of the detected character colors in the character part of the character area image is two, for example, created are two planes.

A concrete example of extraction in which planes are created will be described. In the case that the character area image includes a character part of AB, which is formed from a blue character of A and a red character of B, the character part extracting unit 13 first cuts a plane including the blue A and a plane including the red B, respectively, from the character area image. The character part extracting unit 13 then extracts character part images respectively from the respective cut planes. The extracted character part images are two in number: a character part image of the blue A and a character part image of the red B.

The binary-changing unit 14 performs a process of binary-changing the character part image extracted by means of the character part extracting unit 13.

The binary compression unit 15 performs a process of binary compression of a binary-changed image binary-changed by means of the binary-changing unit 14. As a method of binary compression, used are an MMR or a JBIG2, for example.

The multi-value compression unit 16 carries out a process of multi-value compression of a character area image for which the second processing series is selected by means of the character kind discriminating unit 12. As a method of multi-value compression, used are a JPEG or a JPEG2000, for example.

Now, described will be an operation of the image processing apparatus 1 in accordance with the invention. FIG. 2 is a flowchart showing an operation of the image processing apparatus 1 in accordance with the invention.

In a character area separating step, a character area image and a background area image are separated in bit map image data by layout analysis (S11).

In a character kind discriminating step, the number of character colors in a character part of the character area image separated in the character area separating step is compared with a preset threshold of the number of character colors to select a first processing series as a subsequent process when the number of character colors in the character part is equal to or less than the threshold and to select a second processing series as a subsequent process when the number of character colors in the character part exceeds the threshold (S12).

In a character part extracting step, a character part image is extracted from a character area image for which the first processing series is selected in the character kind discriminating step (S13).

In a binary-changing step, the character part image extracted in the character part extracting step is binary-changed (S14).

In a binary compression step, a binary-changed image binary-changed in the binary-changing step is binary-compressed (S15).

In a multi-value compression step, a character area image for which the second processing series is selected in the character kind discriminating step is multi-value-compressed (S16).

Effects of the image processing apparatus 1 shown in the first embodiment and the image processing method using the image processing apparatus 1 will be described.

In accordance with the image processing apparatus 1 shown in the first embodiment and the image processing method using the image processing apparatus 1, the data of an image obtained by an image composing method for pasting plural images to create a picture can be efficiently reduced in quantity while an image can be formed into data without deteriorating color information of a character and the shape of a character particularly for a texture character or a gradation character.

### Second Embodiment

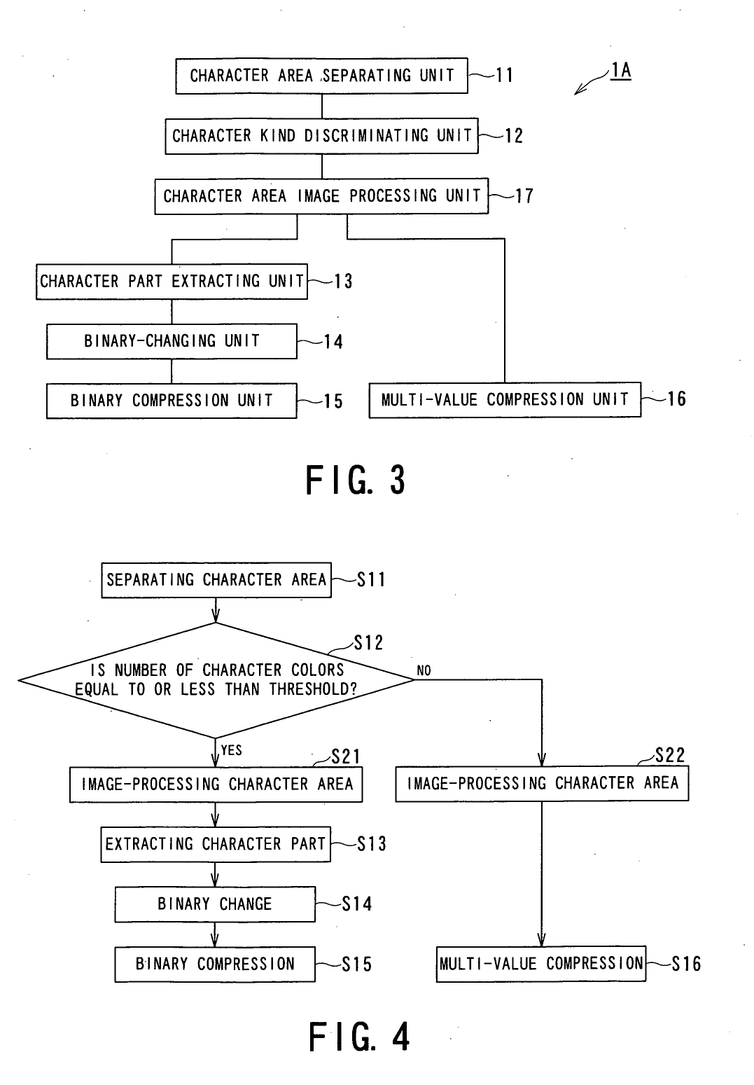

Now, a second embodiment of the image processing apparatus in accordance with the invention will be described, made reference to FIGS. 3 and 4.

An image processing apparatus 1A shown in the second embodiment is different from the image processing apparatus 1 shown in the first embodiment in that a character area image processing unit 17 is provided between the character kind discriminating unit 12 and the character part extracting unit 13 and between the character kind discriminating unit 12 and the multi-value compression unit 16. A structure and an operation of the image processing apparatus 1A other than the above are same as those of the image processing apparatus 1 shown in the first embodiment. Accordingly, the same members are marked with the same reference signs and numerals and description will be simplified or omitted.

FIG. 3 is a functional block diagram of the image processing apparatus 1A in accordance with the invention.

The image processing apparatus 1A shown in the second embodiment comprises the character area separating unit 11, the character kind discriminating unit 12 connected to the character area separating unit 11, the character area image processing unit 17 connected to the character kind discriminating unit 12, the character part extracting unit 13 connected to the character area image processing unit 17, the binary-changing unit 14 connected to the character part extracting unit 13, the binary compression unit 15 connected to the binary-changing unit 14 and the multi-value compression unit 16 connected to the character area image processing unit 17.

The character area image processing unit 17 performs an image process for a character area image for which the first or second processing series is selected by means of the character kind discriminating unit 12.

The character area image processing unit 17 carries out the image process for the purpose of efficiently performing the subsequent process or improving picture quality. Concretely, the image process carried out by the character area image processing unit 17 includes processes of sharpening, smoothing, noise removing, edge emphasizing and color correcting an image and such.

In the image processing apparatus 1A, the character area image processing unit 17 is provided between the character kind discriminating unit 12 and the character part extracting unit 13. Accordingly, the character part extracting unit 13 carries out a process of extracting a character part image from a character area image obtained by image-processing by means of the character area image processing unit 17 the character area image for which the first processing series is selected by means of the character kind discriminating unit 12.

In the image processing apparatus 1A, the character area image processing unit 17 is provided between the character kind discriminating unit 12 and the multi-value compression unit 16. Accordingly, the multi-value compression unit 16 carries out a process of multi-value compression of a character area image obtained by image-processing by means of the character area image processing unit 17 the character area image for which the second processing series is selected by means of the character kind discriminating unit 12.

Now, described will be an operation of the image processing apparatus 1A in accordance with the invention. FIG. 4 is a flowchart showing an operation of the image processing apparatus 1A in accordance with the invention.

S11 and S12 are same as the operation of the image processing apparatus 1, and therefore, description thereof is omitted.

The image processing apparatus 1A carries out a character area image processing step after S12.

In the character area image processing step, after the character kind discriminating step (S12), an image process is performed for the character area image for which the first processing series is selected (S21) or an image process is performed for the character area image for which the second processing series is selected (S22). There is substantially no difference in content of the image process between S21 and S22.

In the case that an image process is performed in the character area image processing step for the character area image for which the first processing series is selected (S21), the character part extracting step (S13) is performed subsequently to the character area image processing step (S21).

That is to say, in the character part extracting step, performed is a process (S13) of extracting a character part image from a character area image obtained by image-processing the character area image for which the first processing series is selected in the character kind discriminating step (S12) in the character area image processing step (S21).

S14 and S15 after S13 are same as the operation of the image processing apparatus 1. Accordingly, description thereof is omitted here.

In the case that an image process is performed in the character area image processing step for the character area image for which the second processing series is selected (S22), the multi-value compression step (S16) is performed subsequently to the character area image processing step (S22).

That is to say, in the multi-value compression step, performed is a process (S16) of multi-value compression of a character area image obtained by image-processing a character area image for which the second processing series is selected in the character kind discriminating step (S12) in the character area image processing step (S22).

An effect of the image processing apparatus 1A shown in the second embodiment and the image processing method using the image processing apparatus 1A will be described.

In accordance with the image processing apparatus 1A and the image processing method using the image processing apparatus 1A, performing the character area image process allows the quality of a created picture to be improved more than the case of the image processing apparatus 1 and the image processing method using the image processing apparatus 1.

### Third Embodiment

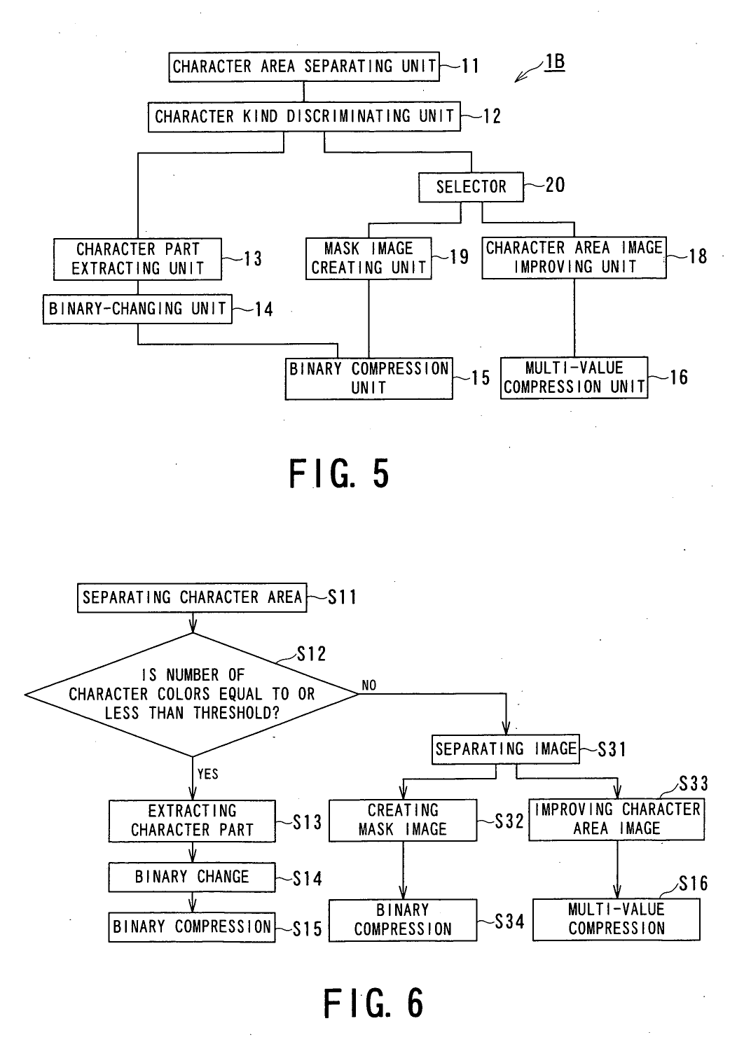

Now, a third embodiment of the image processing apparatus in accordance with the invention will be described with reference to FIGS. 5 and 6.

An image processing apparatus 1B shown in the third embodiment is different from the image processing apparatus 1 shown in the first embodiment in that a selector 20 and a character area image improving unit 18 are provided between the character kind discriminating unit 12 and the multi-value compression unit 16 and in that a route via the selector 20 and a mask image creating unit 19 is provided between the character kind discriminating unit 12 and the binary compression unit 15 as a rout other than a route via the character part extracting unit 13. A structure and an operation of the image processing apparatus 1B other than the above are same as those of the image processing apparatus 1 shown in the first embodiment. Accordingly, the same members are marked with the same reference signs and numerals and description thereof will be simplified or omitted.

FIG. 5 is a functional block diagram of the image processing apparatus 1B in accordance with the invention.

The image processing apparatus 1B shown in the third embodiment comprises the character area separating unit 11, the character kind discriminating unit 12 connected to the character area separating unit 11, the character part extracting unit 13 connected to the character kind discriminating unit 12, the binary-changing unit 14 connected to the character part extracting unit 13, the binary compression unit 15 connected to the binary-changing unit 14 and the mask image creating unit 19, the selector 20 connected to the character kind discriminating unit 12, the character area image improving unit 18 connected to the selector 20, the multi-value compression unit 16 connected to the character area image improving unit 18 and the mask image creating unit 19 connected to the selector 20.

The mask image creating unit 19 creates a mask image in accordance with the character area image for which the second processing series is selected in the character kind discriminating unit 12, the mask image having the shape of a character part of the character area image.

The mask image in the above context means an image including an area in the shape of a character part and a surrounding area other than the area in the shape of a character part and functioning so as to select the character part and the part other than the character part of the mask image to be transparent or opaque, respectively. For example, giving a command of opaque to the character part of the mask image and a command of transparent to the part other than the character part allows a character color to be given to the character part of the mask image when an and-operation is carried out for the mask image and another image.

Binary-changing a character area image, for example, can create the mask image.

The character area image improving unit 18 creates a color information image of the character area image for which the second processing series is selected by means of the character kind discriminating unit 12 in accordance with the character area image. The color information image in the above context means an image having color information of a character part and a background part of a character area image.

The color information image is same as a character area image in having color information of a character part and color information of a background part. The character part of the color information image is, however, only accompanied as the reverse side of the color information, so that the resolution of the character part is not necessary to be taken into account. Accordingly, the resolution of the color information image can be lower than that of the character area image.

In the image processing apparatus 1B, the mask image creating unit 19 is provided between the character kind discriminating unit 12 via the selector 20 and the binary compression unit 15. The binary compression unit 15 thus binary-compresses the mask image 19 in addition to the binary-changed image, which is binary-changed by means of the binary-changing unit 14.

Further, in the image processing apparatus 1B, the character area image improving unit 18 is provided between the character kind discriminating unit 12 via the selector 20 and the multi-value compression unit 16. The multi-value compression unit 16 thus multi-value-compresses the color information image created by means of the character area image improving unit 18.

Now, described will be an operation of the image processing apparatus 1B in accordance with the invention. FIG. 6 is a flowchart showing an operation of the image processing apparatus 1B in accordance with the invention.

S11 and S12 are same as the operation of the image processing apparatus 1, and therefore, description thereof is omitted.

In the case that the first processing series is selected in S12, the subsequent processes (S13 to S15) are same as those in the image processing apparatus 1. Accordingly, description thereof is omitted.

In the case that the second processing series is selected in S12, the image processing apparatus 1B carries out image separation of the character area image (S31) after S12, performs a mask image creating step for one of the separated images, and then, carries out a character area image improving step for the other of the separated images.

In the mask image creating step, created is a mask image including an area having the shape of a character part of the character area image for which the second processing series is selected in the character kind discriminating step (S12) in accordance with the character area image (S32).

After S32, carries out is the binary compression step. In the image processing apparatus 1B, a mask image is also binary-compressed in addition to the binary compression of the binary-changed image (S15) in the binary compression step (S34).

In the character area image improving step, created is a color information image of the character area image for which the second processing series is selected in the character kind discriminating step (S12) in accordance with the character area image (S33).

The multi-value compression step is performed after S33. In the image processing apparatus 1B, a color information image created in the character area image improving step is multi-value-compressed in the multi-value compression step (S16).

Effects of the image processing apparatus 1B shown in the third embodiment and the image processing method using the image processing apparatus 1B will be described.

In accordance with the image processing apparatus 1B and the image processing method using the image processing apparatus 1B, the data of an image obtained by the image composing method for pasting plural images to create a picture can be more efficiently reduced in quantity than the case of the image processing apparatus 1 and the image processing method using the image processing apparatus 1 while an image can be formed into data without deteriorating color information of a character and the shape of a character.

The character area image improving unit 18 may be subdivided more to form the image processing apparatus 1B. Four examples (18A, 18B, 18C and 18D) of subdivision of the character area image improving unit 18 will be now described.

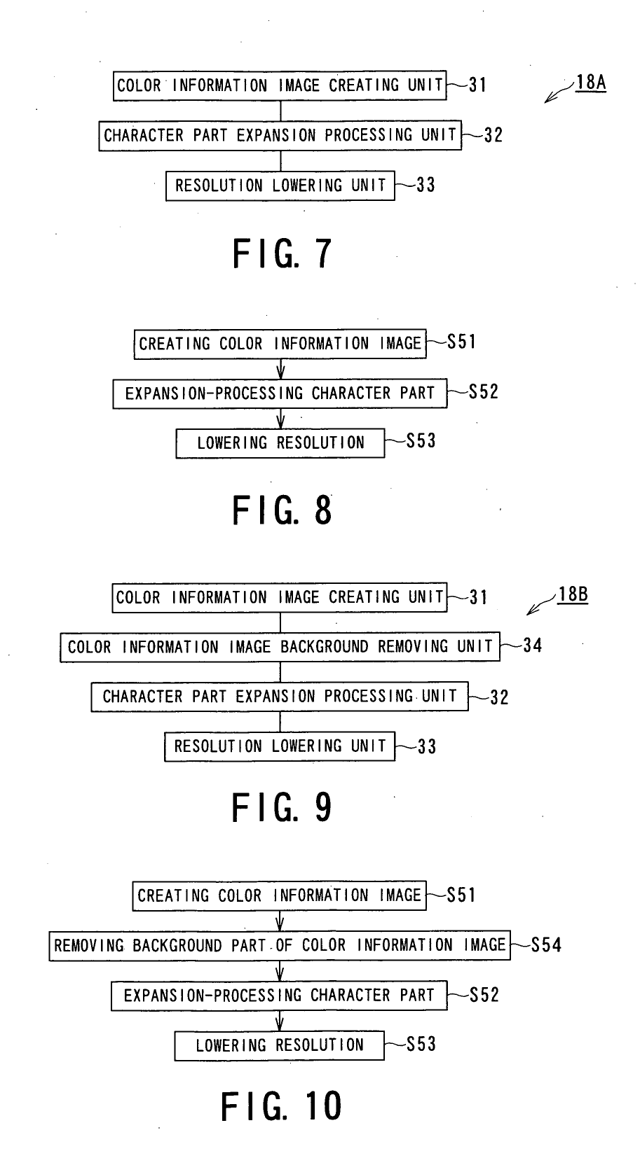

FIG. 7 is a functional block diagram of the character area image improving unit 18A.

The character area image improving unit 18A comprises a color information image creating unit 31, a character part expansion processing unit 32 connected to the color information image creating unit 31 and a resolution lowering unit 33 connected to the character part expansion processing unit 32.

The color information image creating unit 31 creates a color information image of the character area image for which the second processing series is selected by means of the character kind discriminating unit 12 in accordance with the character area image.

The character part expansion processing unit 32 expands the width of a line of a character part of the color information image.

The resolution lowering unit 33 lowers the resolution of the color information image, which is obtained by carrying out a process by means of the character part expansion processing unit 32 and whose width of a line is expanded.

An operation of the character area image improving unit 18A will be now described. FIG. 8 is a flowchart showing an operation of the character area image improving unit 18A.

In a color information image creating step, created is a color information image of the character area image for which the second processing series is selected by means of the character kind discriminating unit 12 in accordance with the character area image (S51).

In a character part expansion processing step, expanded is the width of a line of a character part of the color information image (S52).

When the character area image improving unit 18A is provided, the expansion process of the width of a line of a character part of the color information image relatively causes removal of a background part in the vicinity of the character part of the color information image. This allows reflection of the background color of the color information image in an edge part of a character part of a mask image to be kept down in forming an image by composing the color information image with the mask image.

In a resolution lowering step, the color information image, which is obtained by carrying out a process in the character part expansion processing step (S52) and whose width of a line is expanded, is lowered in resolution (S53). Lowering the resolution of the color information image allows the color information image to be compressed.

FIG. 9 is a functional block diagram of the character area image improving unit 18B.

The character area image improving unit 18B comprises a color information image creating unit 31, a color information image background removing unit 34 connected to the color information image creating unit 31, a character part expansion processing unit 32 connected to the color information image background removing unit 34 and a resolution lowering unit 33 connected to the character part expansion processing unit 32.

The character area image improving unit 18B is same as the character area image improving unit 18A other than the color information image background removing unit 34. Accordingly, the same members are marked with the same reference signs and numerals and description thereof is simplified or omitted.

The color information image background removing unit 34 removes colors of a background part of the color information image. Completely covering a background part with the color of white, for example, can remove colors of the background part.

An operation of the character area image improving unit 18B will be now described. FIG. 10 is a flowchart showing an operation of the character area image improving unit 18B.

After S51, colors of a background part of the color information image are removed in a color information image background removing step (S54).

S52 and S53 are performed after S54, similarly to the case of the character area image improving unit 18A.

Providing the character area image improving unit 18B allows colors of a background part to be removed, and thereby, unnecessary data to be removed. Accordingly, the color information image can be highly compressed more than the case of providing the character area image improving unit 18A.

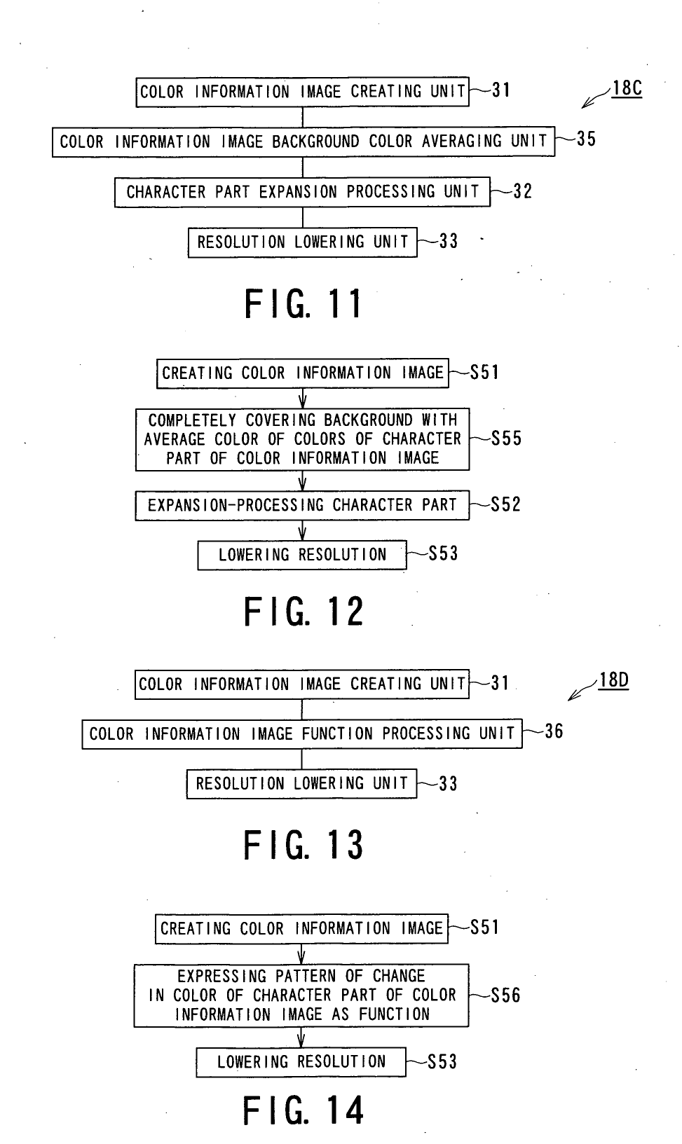

FIG. 11 is a functional block diagram of the character area image improving unit 18C.

The character area image improving unit 18C comprises a color information image creating unit 31, a color information image background color averaging unit 35 connected to the color information image creating unit 31, a character part expansion processing unit 32 connected to the color information image background color averaging unit 35 and a resolution lowering unit 33 connected to the character part expansion processing unit 32.

The character area image improving unit 18C is same as the character area image improving unit 18A other than the color information image background color averaging unit 35. Accordingly, the same members are marked with the same reference signs and numerals and description thereof is simplified or omitted.

The color information image background color averaging unit 35 completely covers a background part of the color information image with an average color of colors of a character part of the color information image.

An operation of the character area image improving unit 18C will be now described. FIG. 12 is a flowchart showing an operation of the character area image improving unit 18C.

A background part of the color information image is completely covered with an average color of colors of a character part of the color information image in a color information image background color averaging step after S51 (S55).

After S55, carried out are S52 and S53, similarly to the character area image improving unit 18A.

When the character area image improving unit 18C is provided, a background part is completely covered with an average color of colors of a character part, so that a variation in color from the background to the character part is decreased. This allows the color information image to be more highly compressed than the case of providing the character area image improving unit 18A and the character area image improving unit 18B.

FIG. 13 is a functional block diagram of the character area image improving unit 18D.

The character area image improving unit 18D comprises a color information image creating unit 31, a color information image function processing unit 36 connected to the color information image creating unit 31 and a resolution lowering unit 33 connected to the color information image function processing unit 36.

The character area image improving unit 18D is same as the character area image improving unit 18A other than the color information image function processing unit 36 and the character part expansion processing unit 32. Accordingly, the same members are marked with the same reference signs and numerals and description thereof is simplified or omitted.

In the color information image function processing unit 36, a pattern of a change in color of a character part of the color information image is expressed by a function. The whole color information image is completely covered with colors on the basis of the function. A pattern of a change in color of a character part can be expressed by a function in the case that the character part is a gradation regularly varying in color or a texture including a fixed pattern such as hatches, dots or stripes.

An operation of the character area image improving unit 18D will be now described. FIG. 14 is a flowchart showing an operation of the character area image improving unit 18D.

In a color information image function processing step after S51, a pattern of a change in color of a character part of the color information image is expressed as a function. The whole color information image is completely covered with colors on the basis of the function (S56).

After S56, carried out is S53, similarly to the character area image improving unit 18A.

When the character area image improving unit 18D is provided, a pattern of a change in color of a character part of the color information image is expressed as a function, so that color information of the color information image can be held in the form of function information having small data capacity instead of the form of pixel information having large data capacity such as RGB. This allows the color information image to be more highly compressed than the case of providing the character area image improving unit 18A, the character area image improving unit 18B and the character area image improving unit 18C.

### Fourth Embodiment

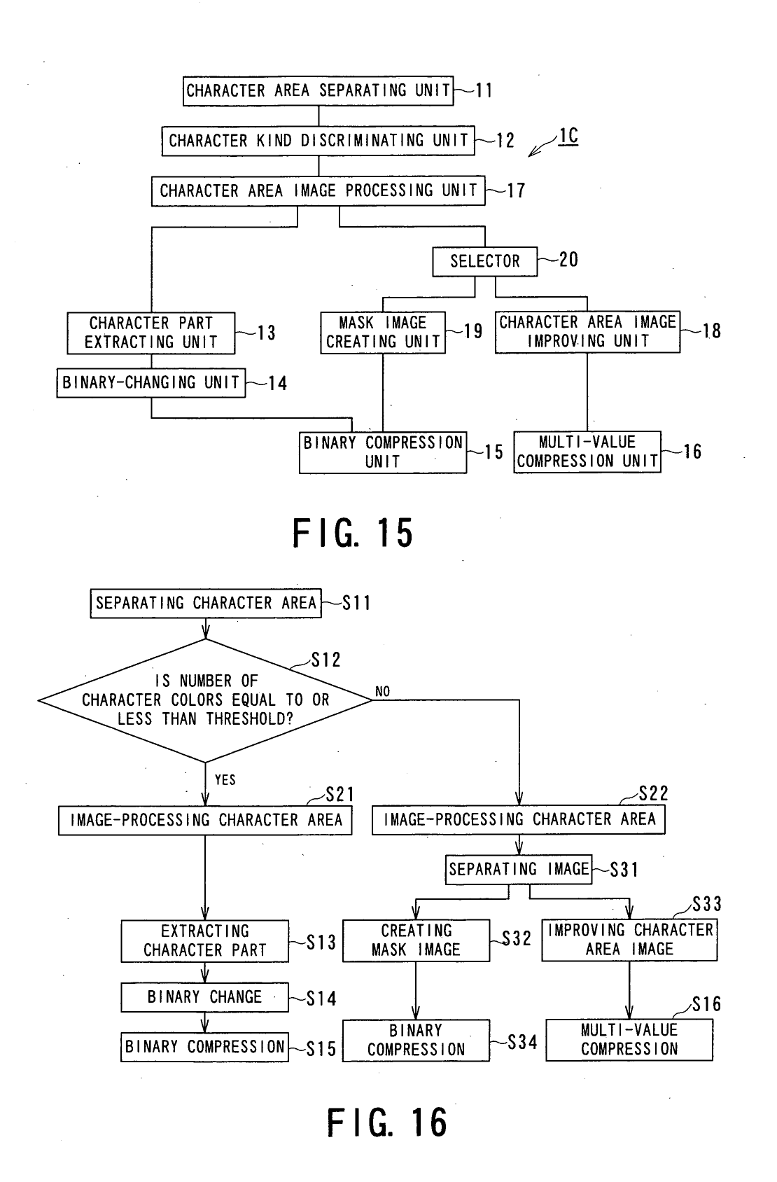

Now, a fourth embodiment of the image processing apparatus in accordance with the invention will be described with reference to FIGS. 15 and 16.

An image processing apparatus 1C shown in the fourth embodiment is different from the image processing apparatus 1 shown in the first embodiment in that a character area image processing unit 17, a selector 20 and a character area image improving unit 18 are provided between the character kind discriminating unit 12 and the multi-value compression unit 16 and in that a route via the character area image processing unit 17, the selector 20 and a mask image creating unit 19 is provided between the character kind discriminating unit 12 and the binary compression unit 15 as a rout other than a route via the character part extracting unit 13. A structure and an operation of the image processing apparatus 1C other than the above are same as those of the image processing apparatus 1 shown in the first embodiment. Accordingly, the same members are marked with the same reference signs and numerals and description thereof will be simplified or omitted.

FIG. 15 is a functional block diagram of the image processing apparatus 1C in accordance with the invention.

The image processing apparatus 1C shown in the fourth embodiment comprises a character area separating unit 11, a character kind discriminating unit 12 connected to the character area separating unit 11, a character area image processing unit 17 connected to the character kind discriminating unit 12, a character part extracting unit 13 connected to the character area image processing unit 17, a binary-changing unit 14 connected to the character part extracting unit 13, a binary compression unit 15 connected to the binary-changing unit 14 and a mask image creating unit 19, a selector 20 connected to the character area image processing unit 17, a character area image improving unit 18 connected to the selector 20, a multi-value compression unit 16 connected to the character area image improving unit 18 and the mask image creating unit 19 connected to the selector 20.

The character area image processing unit 17, the character area image improving unit 18, the mask image creating unit 19 and the selector 20 have been described for the image processing apparatus 1A shown in the second embodiment and the image processing apparatus 1B shown in the third embodiment. Accordingly, the same members are marked with the same reference signs and numerals and description thereof is simplified or omitted.

The mask image creating unit 19 creates a mask image having an area in the shape of a character part of the character area image obtained by image-processing by means of the character area image processing unit 17 the character area image for which the second processing series is selected by means of the character kind discriminating unit 12 from the obtained character area image.

The character area image improving unit 18 creates a color information image of the character area image obtained by image-processing by means of the character area image processing unit 17 the character image for which the second processing series is selected by means of the character kind discriminating unit 12 from the obtained character area image.

In the image processing apparatus 1C, the character area image processing unit 17 is provided between the character kind discriminating unit 12 and the character part extracting unit 13. Accordingly, the character part extracting unit 13 extracts a character part image from a character area image obtained by image-processing by means of the character area image processing unit 17 the character area image for which the first processing series is selected by means of the character kind discriminating unit 12.

In the image processing apparatus 1C, the mask image creating unit 19 is provided between the character kind discriminating unit 12 and the binary compression unit 15 via the selector 20 and the character area image processing unit 17. Accordingly, the binary compression unit 15 binary-compresses the mask image 19 in addition to the binary-changed image, which is binary-changed by means of the binary-changing unit 14.

In the image processing apparatus 1C, the character area image improving unit 18 is provided between the character kind discriminating unit 12 and the multi-value compression unit 16 via the selector 20 and the character area image processing unit 17. The multi-value compression unit 16 thus multi-value-compresses the color information image created by means of the character area image improving unit 18.

Now, described will be an operation of the image processing apparatus 1C in accordance with the invention. FIG. 16 is a flowchart showing an operation of the image processing apparatus 1C in accordance with the invention.

S11 and S12 are same as the operation of the image processing apparatus 1, and therefore, description thereof is omitted.

The image processing apparatus 1C performs a character area image processing step after S12.

In the character area image processing step, after the character kind discriminating step (S12), an image process is carried out for the character area image for which the first processing series is selected (S21) or an image process is carried out for the character area image for which the second series is selected (S22). There is substantially no difference in content of the image process between S21 and S22.

In the case that an image process is performed for the character area image for which the first processing series is selected (S21) in the character area image processing step, the character part extracting step (S13) is performed subsequently to the character area image processing step (S21).

That is to say, in the character part extracting step, performed is a process (S13) of extracting a character part image from a character area image obtained by image-processing the character area image for which the first processing series is selected in the character kind discriminating step (S12) in the character area image processing step (S21).

S14 and S15 after S13 are same as the operation of the image processing apparatus 1. Accordingly, description thereof is omitted here.

In the case that an image process is performed for the character area image for which the second processing series is selected (S22) in the character area image processing step, the image processing apparatus 1C carries out image separation of the character area image (S31) after S22, the mask image creating step is performed for one of the separated images, and then, the character area image improving step for the other of the separated images.

In the mask image creating step, created is a mask image having an area in the shape of a character part of the character area image obtained by image-processing in the character area image processing step (S22) the character area image for which the second processing series is selected in the character kind discriminating step (S12) from the obtained character area image (S32).

After S32, carried out is the binary compression step. In the image processing apparatus 1C, the mask image is also binary-compressed in addition to the binary compression of the binary-changed image (S15) in the binary compression step (S34).

In the character area image improving step, created is a color information image of the character area image obtained by image-processing in the character area image processing step (S22) the character area image for which the second processing series is selected in the character kind discriminating step (S12) from the obtained character area image (S33).

The multi-value compression step is performed after S33. In the image processing apparatus 1C, a color information image created in the character area image improving step is multi-value-compressed in the multi-value compression step (S16).

Effects of the image processing apparatus 1C shown in the fourth embodiment and the image processing method using the image processing apparatus 1C will be described.

In accordance with the image processing apparatus 1C and the image processing method using the image processing apparatus 1C, the image processing apparatus 1C is formed from a combination of the image processing apparatus 1A and the image processing apparatus 1B, so that a character area image process is carried out. This allows the quality of a created picture to be improved more than the case of the image processing apparatus 1 and the image processing method using the image processing apparatus 1. Moreover, the data of an image obtained by an image composing method for pasting plural images to create a picture can be more efficiently reduced in quantity than the case of the image processing apparatus 1 and the image processing method using the image processing apparatus 1 while an image can be formed into data without deteriorating color information of a character and the shape of a character.

What is claimed is:

1. An image processing apparatus comprising:
a character area separating unit for separating a character area image and a background area image of bit map image data by means of layout analysis;
a character kind discriminating unit for comparing the number of character colors of a character part of the character area image separated by means of the character area separating unit with a preset threshold of the number of character colors to select a first processing series when the number of character colors of the character part is equal to or less than the threshold and to select a second processing series when the number of character colors of the character part exceeds the threshold;
a character part extracting unit for extracting a character part image from the character area image for which the first processing series is selected by means of the character kind discriminating unit;
a binary-changing unit for binary-changing the character part image extracted by means of the character part extracting unit;
a binary compression unit for binary-compressing a binary-changed image binary-changed by means of the binary-changing unit; and
a multi-value compression unit for multi-value-compressing the character area image for which the second processing series is selected by means of the character kind discriminating unit.

2. The image processing apparatus according to claim 1, further comprising
a character area image processing unit for carrying out an image process for the character area image for which the first or second processing series is selected by means of the character kind discriminating unit, wherein
the character part extracting unit extracts a character part image from a character area image obtained by image-processing by means of the character area image processing unit the character area image for which the first processing series is selected by means of the character kind discriminating unit and
the multi-value compression unit multi-value-compresses a character area image obtained by image-processing by means of the character area image processing unit the character area image for which the second processing series is selected by means of the character kind discriminating unit.

3. The image processing apparatus according to claim 1, further comprising:
a mask image creating unit for creating a mask image having an area in the shape of a character part of the character area image for which the second processing series is selected by means of the character kind discriminating unit from the character area image; and
a character area image improving unit for creating a color information image of the character area image for which the second processing series is selected by means of the character kind discriminating unit from the character area image, wherein
the binary compression unit also binary-compresses the mask image in addition to the binary-changed image and
the multi-value compression unit multi-value-compresses the color information image.

4. The image processing apparatus according to claim 1, further comprising:
a character area image processing unit for carrying out an image process for the character area image for which the first or second processing series is selected by means of the character kind discriminating unit;
a mask image creating unit for creating a mask image having an area in the shape of a character part of a character area image obtained by image-processing by means of the character area image processing unit the character area image for which the second processing series is selected by means of the character kind discriminating unit from the obtained character area image; and
a character area image improving unit for creating a color information image of the character area image obtained by image-processing by means of the character area image processing unit the character area image for which the second processing series is selected by means of the character kind discriminating unit from the obtained character area image, wherein
the character part extracting unit extracts a character part image from a character area image obtained by image-processing by means of the character area image processing unit the character area image for which the first processing series is selected by means of the character kind discriminating unit,
the binary compression unit also binary-compresses the mask image in addition to the binary-changed image and
the multi-value compression unit multi-value-compresses the color information image.

5. The image processing apparatus according to claim 1, wherein
the character kind discriminating unit judges the number of character colors of the character part of the character area image separated by means of the character area separating unit on the basis of color information obtained from a specific area of the character part of the character area image.

6. The image processing apparatus according to claim 1, wherein
the character kind discriminating unit judges the number of character colors of the character part of the character area image separated by means of the character area separating unit on the basis of a histogram of the character part of the character area image.

7. The image processing apparatus according to claim 3, wherein
the character area image improving unit comprises:
a color information image creating unit for creating a color information image of the character area image for which the second processing series is selected by means of the character kind discriminating unit from the character area image;
a character part expansion processing unit for expanding the width of a line of the character part of the color information image; and
a resolution lowering unit for lowering the resolution of the color information image obtained by a process by means of the character part expansion processing unit, the color information image having the expanded width of a line.

8. The image processing apparatus according to claim 3, wherein
the character area image improving unit comprises:
a color information image creating unit for creating a color information image of the character area image for which the second processing series is selected by means of the character kind discriminating unit from the character area image;
a color information image background removing unit for removing a color of a background part of the color information image;
a character part expansion processing unit for expanding the width of a line of the character part of the color information image processed by means of the color information image background removing unit; and
a resolution lowering unit for lowering the resolution of the color information image obtained by a process by means of the character part expansion processing unit, the color information image having the expanded width of a line.

9. The image processing apparatus according to claim 3, wherein
the character area image improving unit comprises:
a color information image creating unit for creating a color information image of the character area image for which the second processing series is selected by means of the character kind discriminating unit from the character area image;
a color information image background color averaging unit for completely covering a background part of the color information image with an average color of colors of the character part of the color information image;
a character part expansion processing unit for expanding the width of a line of the character part of the color information image processed by means of the color information image background color averaging unit; and
a resolution lowering unit for lowering the resolution of the color information image obtained by a process by means of the character part expansion processing unit, the color information image having the expanded width of a line.

10. The image processing apparatus according to claim 3, wherein
the character area image improving unit comprises:
a color information image creating unit for creating a color information image of the character area image for which character kind discriminating unit from the character area image; the second processing series is selected by means of the
a color information image function processing unit for expressing a pattern of a change in color of a character part of the color information image as a function to completely cover the whole color information image with a color on the basis of the function; and
a resolution lowering unit for lowering the resolution of the color information image obtained by a process by means of the color information image function processing unit.

11. An image processing method comprising:
a character area separating step for separating a character area image and a background area image of bit map image data by means of layout analysis;
a character kind discriminating step for comparing the number of character colors of a character part of the character area image separated in the character area separating step with a preset threshold of the number of character colors to select a first processing series when the number of character colors of the character part is equal to or less than the threshold and to select a second processing series when the number of character colors of the character part exceeds the threshold;
a character part extracting step for extracting a character part image from the character area image for which the first processing series is selected in the character kind discriminating step;
a binary-changing step for binary-changing the character part image extracted in the character part extracting step;
a binary compression step for binary-compressing a binary-changed image binary-changed in the binary-changing step; and
a multi-value compression step for multi-value-compressing the character area image for which the second processing series is selected in the character kind discriminating step.

12. The image processing method according to claim 11, further comprising
a character area image processing step for carrying out an image process for the character area image for which the first or second processing series is selected after the character kind discriminating step, wherein
in the character part extracting step, a character part image is extracted from a character area image obtained by image-processing in the character area image processing step the character area image for which the first processing series is selected in the character kind discriminating step and
in the multi-value compression step, multi-value-compressed is a character area image obtained by image-processing in the character area image processing step the character area image for which the second processing series is selected in the character kind discriminating step.

13. The image processing method according to claim 11, further comprising:
a mask image creating step for creating a mask image having an area in the shape of a character part of the character area image for which the second processing series is selected in the character kind discriminating step from the character area image; and
a character area image improving step for creating a color information image of the character area image for which the second processing series is selected in the character kind discriminating step from the character area image, wherein
in the binary compression step, the mask image is also binary-compressed in addition to the binary-changed image and
in the multi-value compression step, the color information image is multi-value-compressed.

14. The image processing method according to claim 11, further comprising:
a character area image processing step for carrying out an image process for the character area image for which the first or second processing series is selected in the character kind discriminating step;
a mask image creating step for creating a mask image having an area in the shape of a character part of a character area image obtained by image-processing in the character area image processing step the character area image for which the second processing series is selected in the character kind discriminating step from the obtained character area image; and
a character area image improving step for creating a color information image of the character area image obtained by image-processing in the character area image processing step the character area image for which the second processing series is selected in the character kind discriminating step from the obtained character area image, wherein
in the character part extracting step, a character part image is extracted from a character area image obtained by image-processing in the character area image processing step the character area image for which the first processing series is selected in the character kind discriminating step,
in the binary compression step, the mask image is also binary-compressed in addition to the binary-changed image and
in the multi-value compression step, the color information image is multi-value-compressed.

15. The image processing method according to claim 11, wherein
in the character kind discriminating step, the number of character colors of a character part of the character area image separated in the character area separating step is judged on the basis of color information obtained from a specific area of the character part of the character area image.

16. The image processing method according to claim 11, wherein
in the character kind discriminating step, the number of character colors of a character part of the character area image separated in the character area separating step is judged on the basis of a histogram of the character part of the character area image.

17. The image processing method according to claim 13, wherein
the character area image improving step comprises:
a color information image creating step for creating a color information image of the character area image for which the second processing series is selected in the character kind discriminating step from the character area image;
a character part expansion processing step for expanding the width of a line of the character part of the color information image; and
a resolution lowering step for lowering the resolution of the color information image obtained by a process in the character part expansion processing step, the color information image having the expanded width of a line.

18. The image processing method according to claim 13, wherein
the character area image improving step comprises:
a color information image creating step for creating a color information image of the character area image for which the second processing series is selected in the character kind discriminating step from the character area image;
a color information image background removing step for removing a color of a background part of the color information image;
a character part expansion processing step for expanding the width of a line of the character part of the color information image processed in the color information image background removing step; and
a resolution lowering step for lowering the resolution of the color information image obtained by a process in the character part expansion processing step, the color information image having the expanded width of a line.

19. The image processing method according to claim 13, wherein
the character area image improving step comprises:
a color information image creating step for creating a color information image of the character area image for which the second processing series is selected in the character kind discriminating step from the character area image;
a color information image background color averaging step for completely covering a background part of the color information image with an average color of colors of the character part of the color information image;
a character part expansion processing step for expanding the width of a line of the character part of the color information image processed in the color information image background color averaging step; and
a resolution lowering step for lowering the resolution of the color information image obtained by a process in the character part expansion processing step, the color information image having the expanded width of a line.

20. The image processing method according to claim 13, wherein
the character area image improving step comprises:
a color information image creating step for creating a color information image of the character area image for which the second processing series is selected in the character kind discriminating step from the character area image;
a color information image function processing step for expressing a pattern of a change in color of a character part of the color information image as a function to completely cover the whole color information image with a color on the basis of the function; and
a resolution lowering step for lowering the resolution of the color information image obtained by a process in the color information image function processing step.
